(19) United States
(12) Patent Application Publication
(10) Pub. No.: US 2010/0327504 A1
(43) Pub. Date: Dec. 30, 2010

(54) Clamp Assembly

(76) Inventor: Charles Seidel, Royal Oak, MI (US)

Correspondence Address: McPherson IP Law Office PLLC, P.O. Box 81876, Rochester, MI, 48308, US

(21) Appl. No.: 12/493,230

(22) Filed: Jun. 28, 2009

(51) Int. Cl. B25B 5/16; B25B 5/02

(52) U.S. Cl. 269/43; 269/165; 269/283

(57) ABSTRACT

The present invention provides methods and devices for clamping components of a workpiece together. In one exemplary embodiment, the invention provides a bar clamp assembly including a guide rail extending along an axis between a first end and a second end. The bar clamp assembly also includes a slide jaw disposed along the guide rail having a first abutment surface and a first support surface and a fixed jaw attached to the guide rail having a second abutment surface and a second support surface. The clamp assembly further includes a compress mechanism disposed with the slide jaw. The compress mechanism includes a moveable member configured to move the first abutment surface towards the second abutment surface. The first and second support surfaces extend generally perpendicular to the first and second abutment surfaces and provide reactionary force to compressive forces applied perpendicular to the guide rail axis.

### FIELD OF THE INVENTION

The present invention relates to clamp assemblies, particularly arm or bar clamp assemblies, having one or more moveable members configured to compress a workpiece in one or more directions.

### BACKGROUND

Clamps are often used in the woodworking field to join and hold components together while adhesives and/or fasteners are used to maintain the components together. One particular group of clamps that are often used includes the arm, body or bar clamp or other similar type clamp, hereinafter referred to as bar clamp. The bar clamp includes a moveable member, such as a slide jaw, configured to move along a length of the bar clamp, such as along a guide rail, to cause compression or squeezing of components of a workpiece. This compressive force is the result of the moveable member compressing the components against an opposing member, such as a fixed jaw, of the bar clamp. The opposing member is suitable in strength to allow a substantial amount of compressive force to be applied to the components of the workpiece. Such compressive force is desired, and often needed, to ensure that the components are properly joined and aligned during fastening of the same.

In certain applications it has become advantageous to generate compressive forces in multiple direction with respect to components of a workpiece. For example, with continued reference to the bar clamp, at times it is advantageous to generate forces both longitudinally along the length of the bar clamp as well as laterally, i.e. generally perpendicular to the longitudinal force, to ensure that the components maintain position with respect to one another during attachment. In this regard, few manufactures have developed products capable of generating multiple forces onto a workpiece, particularly with respect to bar clamps. In the only known instance, an edge clamp, that is attachable to the bar clamp and able to generate a force generally perpendicular with respect to the compressive force generated along a length of the bar clamp, is available for purchase, separate from the bar clamp. However, these edge clamps provide little more function than a positioning means for a workpiece as the clamps are capable of relatively little compressive force, as compared to the compressive force generated along the length of the bar clamp. This is due to the lack of support acting upon the workpiece as the edge clamp applies the lateral compressive force to the workpiece. At best, the only resistance to the edge clamp is the friction force generated between the components of the workpiece and the bar clamp. Accordingly, as soon as the compressive force of the edge clamp overcomes the friction force, the components of the workpiece moves away from the bar clamp thereby rendering the edge clamp ineffective for applying meaningful compressive force.

In one particular application, it has been discovered that existing bar clamps, along with edge clamps, are ineffective for joining longer workpiece components together, such as boards, panels or otherwise. This is due to the inability of the bar clamp to generate lateral compressive force, as described above. Accordingly, should one desire to form a multi-layered panel, such as a plywood board or the like, they are required to purchase specialized clamps, which incurs cost for the additional tool and added steps to the overall production of a final workpiece.

In view of the foregoing, there is a need for methods and devices for improving available clamping forces onto a workpiece. More so, there is a need for an improved bar clamp assembly capable of providing improved multiple compressive forces to a workpiece, particularly at least one suitable force that is generally perpendicular to compressive force applied along a length of the bar clamp.

### SUMMARY OF THE INVENTION

The present invention provides exemplary embodiments of methods and devices for clamping components of a workpiece together. More so, in one embodiment, the present invention provides a bar clamp assembly configured for generating compressive forces in multiple directions.

In one exemplary embodiment, the invention provides a bar clamp assembly. The bar clamp assembly includes a guide rail extending along an axis between a first end and a second end. The bar clamp assembly also includes a slide jaw disposed along the guide rail, the slide jaw includes a first abutment surface and a first support surface. The bar clamp assembly further includes a fixed jaw attached to the guide rail proximate the first or second end, the fixed jaw includes a second abutment surface and a second support surface. The clamp assembly further includes a compress mechanism disposed with the slide jaw. The compress mechanism includes a moveable member configured to move the first abutment surface towards the second abutment surface for generating a compressive force generally parallel to the guide rail axis. The first and second support surfaces provide reactionary force to compressive force applied generally perpendicular to the guide rail axis.

In another exemplary embodiment, the invention provides a clamp system for joining multiple layers of a workpiece together. The clamp system includes a plurality of bar clamp assemblies. Each of the plurality of bar clamp assemblies includes a guide rail extending along an axis between a first end and a second end. The bar clamp assemblies also includes a slide jaw disposed along the guide rail, the slide jaw includes a first abutment surface and a first support surface. The bar clamp assemblies further includes a fixed jaw attached to the guide rail proximate the first or second end, the fixed jaw includes a second abutment surface and a second support surface. The clamp assemblies still further include a compress mechanism disposed with the slide jaw. The compress mechanism includes a moveable member configured to move the first abutment surface towards the second abutment surface for generating a compressive force generally parallel to the guide rail axis. The first and second support surfaces provide reactionary force to compressive force applied generally perpendicular to the guide rail axis. The clamp system further includes a plurality of clamp mechanisms disposed between the guide rail and the first and second support surfaces. The one or more clamp mechanisms are configured to expand to generate the compressive force that is generally perpendicular to the guide rail axis.

The above-described and other features and advantages of the present invention will be appreciated and understood by those skilled in the art from the following detailed description, drawings, and appended claims.

### BRIEF DESCRIPTION OF THE DRAWINGS

Other objects, features, advantages and details of the present invention appear, by way of example only, in the following detailed description of preferred embodiments of the invention, the detailed description referring to the drawings in which:

FIG. 1 illustrates a prior art bar clamp assembly;

FIG. 2 illustrates a first embodiment of a bar clamp assembly according to the teachings of the present invention;

FIG. 3 illustrates a second embodiment of a bar clamp assembly according to the teachings of the present invention;

FIG. 4 illustrates a third embodiment of a bar clamp assembly according to the teachings of the present invention;

FIG. 5 illustrates an exploded perspective view of a first support member shown in FIG. 4;

FIG. 6 illustrates an exploded perspective view of a second support member according to the teachings of the present invention;

FIG. 7 illustrates an exploded perspective view of a third support member according to the teachings of the present invention;

FIG. 8 illustrates a perspective view of a fourth support member according to the teachings of the present invention;

FIG. 9 illustrates a bottom view of a fifth support member according to the teachings of the present invention;

FIG. 10 illustrates a fourth embodiment of a bar clamp assembly according to the teachings of the present invention;

FIG. 11 illustrates an exploded perspective view of removable support members shown in FIG. 10;

FIG. 11A illustrates a cross-sectional view of the removable support members shown in FIG. 11;

FIG. 12 illustrates a cross-sectional view of an exemplary embodiment of a clamping system according to the teachings of the present invention;

FIG. 13 illustrates a cross-section view of the clamp system shown in FIG. 12;

FIG. 13A illustrates a top plan view of the clamping system shown in FIG. 13;

FIGS. 14 and 15 illustrate a first embodiment of a clamp mechanism according to the teachings of the present invention;

FIGS. 16 and 17 illustrate a second embodiment of a clamp mechanism according to the teachings of the present invention;

FIG. 18 illustrates a cross-sectional view of the clamp mechanism shown in FIGS. 16 and 17; and

FIG. 19 illustrates an exploded perspective view of the clamp mechanism shown in FIG. 18.

### DESCRIPTION OF THE PREFERRED EMBODIMENTS

The present invention provides methods and devices for forming and maintaining even pressure against one or more components of a workpiece. The application of pressure is particularly advantageous during assembly of components to form a final product, or subcomponent thereof, wherein during application of pressure the components are fixedly attached to one another through any suitable attachment means, e.g., fasteners, adhesives or otherwise. Upon attachment, the pressure is discontinued and the components are maintained together through the attachment means.

In one particular configuration, the above referenced methods and device are derived through an improved bar clamp assembly. It should be appreciated that the bar clamp assembly may comprise, without limitation, clamps having a first jaw moveable along a guide rail, bar, rod or the like, and a second fixed jaw that is fixedly attached or integrally formed with the guide rail. Accordingly, such clamps may comprise bar clamps, jaw clamps, body clamps or other similar clamps. The bar clamp assembly is configured to generate a first compressive force along a length of the bar clamp assembly and at least one other compressive force that is generally perpendicular to the first compressive force. In this configuration, the bar clamp includes a first moveable member, such as a slide jaw, and a first opposing member, such as a fixed jaw, that act to compress a workpiece along a guide rail axis. However, it should be appreciated that the fixed jaw may be moveable and/or configured for attachment at different points along the length of the guide rail. The bar clamp further includes a second moveable member, such as an edge or other clamp such as described herein or otherwise, and a second opposing member that acts to compress a workpiece along a second axis that is non-parallel to the first axis or even generally perpendicular to the first axis. It should be appreciated that additional moveable members and opposing members may be utilized.

The methods and devices of the present invention improve on previous clamping devices, particularly bar and other similar type clamps, as they are able to generate suitable compressive forces along multiple axes. As previously mentioned, this is not the case with previous bar clamp and edge clamp configurations.

For example, with reference to FIG. 1, a prior bar clamp assembly 1 configured for applying pressure against a workpiece 2 is shown. The bar clamp assembly 1 includes a slide jaw 3 located at a first end of the bar clamp assembly and a fixed jaw 4 located on a second end of the bar clamp assembly. The slide jaw 3 is slideably mounted to a guide rail 5 of the bar clamp assembly 1 and the fixed jaw 4 is fixedly attached to the guide rail 5. During movement of the slide jaw 3 towards the fixed jaw 4 a first pressure ‘P1’ is generated on a workpiece 2 thereby generating a friction force ‘F’ between the bar clamp assembly 1, via slide jaw 3 and fixed jaw 4, and workpiece 2. The bar clamp assembly 1 further includes two edge clamps 6 configured to generate a second pressure ‘P2’ against the workpiece 2 in a direction generally perpendicular to the direction of the first pressure ‘P1’. However, the second pressure ‘P2’ is limited by the friction force ‘F’ formed between the bar clamp assembly 1 and the workpiece 2. It has been discovered that in certain situations it is advantageous to generate pressure against the workpiece 2 in excess of friction force ‘F’ generated between the bar clamp assembly 1 and the workpiece 2. For example, as previously mentioned, during joining of multiple layers, such as panels 7, 8 to form a laminate, suitable pressure in excess of the friction force ‘F’ is desired to ensure proper joining of the layers such that minimal gaps are formed between panels 7, 8 and to ensure that movement of the workpiece 2 does not occur.

The present invention improves upon the above referenced configuration by providing improved clamping to components of a workpiece. Referring to FIGS. 2, 3, 10 and 12, different configurations of bar clamp assemblies of the present invention are shown. In each of these configurations, the bar clamp assembly includes a feature for providing a support to a clamp member that is orientated to assist in the formation of a compressive force that is generally perpendicular to the compressive force generated along the length of the bar clamp.

Referring to FIG. 2, a first configuration of a bar clamp assembly 10 of the present invention is shown. The bar clamp assembly 10 includes a slide jaw 12 slideably mounted to a guide rail 14 extending along an axis ‘A’, between a first end 16 and a second end 18. The bar clamp assembly 10 further includes a fixed jaw 20 fixedly mounted to the second end 18 of the guide rail 14. However, as previously mentioned the fixed jaw may be mounted at other locations along the guide rail. The slide jaw 12 includes a rail engagement member 22 configured to engage grooves 24 formed by the guide rail 14 for preventing movement of the slide jaw 12 with respect to the guide rail 14, particularly during engagement of the slide jaw 12 with a workpiece 26. The slide jaw 12 further includes a first workpiece engagement member 28 that is configured to engage the workpiece 26 and move with respect to the rail engagement member 22, through a compress mechanism 29. The compress mechanism 29 includes a first spindle 30 is threadably engaged with the rail engagement member 22 to cause movement of the first workpiece engagement member 28, with respect to the rail engagement member. Similarly, the fixed jaw 20 includes a second workpiece engagement member 32 that is rigidly secured to the guide rail 14. Upon rotation of the first spindle 30, the first and second workpiece engagement members 28, 32 are brought towards each other to engage the workpiece and cause compression in a direction generally parallel with respect to the guide rail axis A.

The bar clamp assembly 10 may further include one or more edge clamps 34 configured to generated compressive force against the workpiece in a direction generally perpendicular to the guide rail axis ‘A’. In this configuration, the edge clamps 34 are fixedly attached to the guide rail 14, through a lock mechanism 36, and include a second spindle 38 configured to move an engagement member 40 against the workpiece 26. The bar clamp assembly 10 further includes a first support member 42 disposed with the slide jaw 12 and a second support member 44 disposed with the fixed jaw 20. Upon rotation of the second spindle 38, the engagement member 40 compresses the workpiece against the first and second support members 42, 44.

In this configuration, the slide jaw 12 and the fixed jaw 20 are each configured to provide a support to each other and to the edge clamps 34. To this end, the first workpiece engagement member 28 includes a first abutment surface 46 for engaging and applying a force to the workpiece 26 and the second workpiece engagement member 32 includes a second abutment surface 48 also for engaging and applying a force to the workpiece, opposite of the first abutment surface 46. The first and second abutment surfaces 46, 48 extend generally perpendicular with respect to the guide rail axis ‘A’. The first and second workpiece engagement members 28, 32 also include a first support surface 50 formed on a first support member 51 and a second support surface 52 formed on a second support member 53, respectively. The first and second support surfaces 50, 52 extend generally parallel with respect to the guide rail axis ‘A’ and generally perpendicular with respect to the first and second abutment surfaces 46, 48. The first and second support surfaces 50, 52 extend a suitable length ‘1’ beyond the first and second abutment surfaces 46, 48 to provide suitable strength for providing sufficient reactionary force to edge clamps 34 or otherwise, without damaging the workpiece

Referring to FIG. 3, a second configuration of a bar clamp assembly 110 of the present invention is shown. Similar to the first embodiment, the bar clamp assembly includes a slide jaw 112 that is mounted to a guide rail 114 extending along an axis ‘A’ at or between a first end 116 and a second end 118. The bar clamp assembly 110 also includes a fixed jaw 120 fixedly attached to the guide rail 114 at the second end 118 of the bar clamp assembly 110. Through a first workpiece engagement member 128 of the slide jaw 112 and a second workpiece engagement member 132 of the fixed jaw 120, a compressive force is applied to a workpiece 126 in a direction generally parallel with respect to a length of the guide rail 114. Similarly, the bar clamp assembly 110 includes one or more edge clamps 134 and a first support member 142 and a second support member 144, which provides a reactionary compressive force that is generally perpendicular with respect to the guide rail axis ‘A’.

In this configuration the first workpiece engagement member 128 includes a recessed first abutment surface 146 and the second workpiece engagement member 132 includes a recessed second abutment surface 148. Through these recesses, a first support surface 150 is formed with the first workpiece engagement member 128 and a second support surface 152 is formed with the second workpiece engagement member 132. Advantageously, not only do the recesses assist in the formation of the first and second support surfaces 150, 152, but also improve on installation of the bar clamp assembly onto a workpiece 126 and provides additional control of the workpiece by limiting movement of the workpiece towards and away from the guide rail 114.

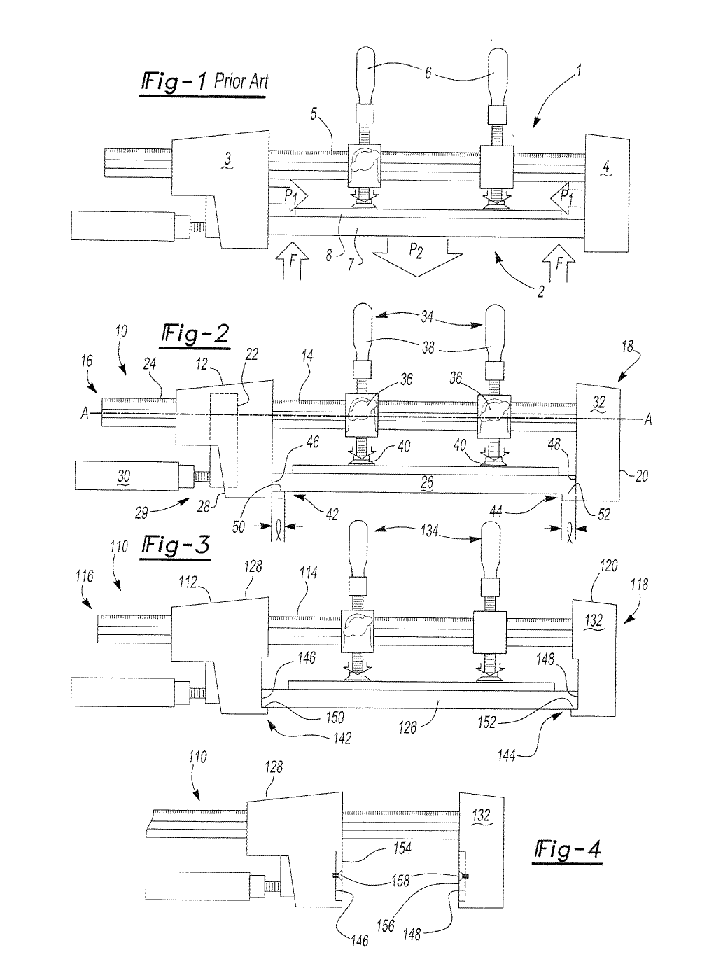

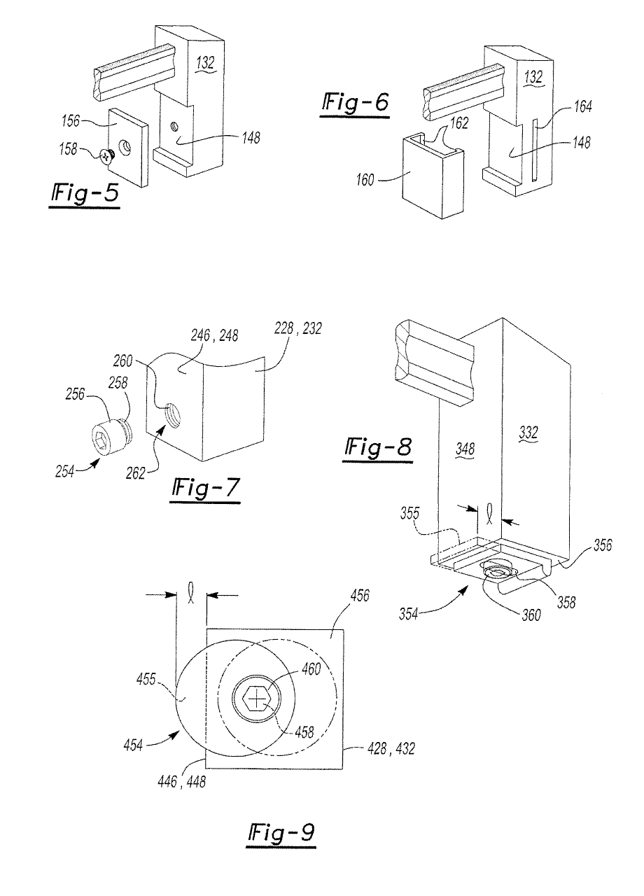

In one configuration, the bar clamp assembly 110 further includes one or more plugs for filing all or a portion of the first and second recessed abutment surfaces 146, 148. This is particularly advantageous when edge or other similar type clamps are not used and the user of the bar clamp assembly desires a substantially flat and/or continuous surface across the first and second workpiece engagement feature. In a first example, with reference to FIGS. 4 and 5, the bar clamp assembly 110 further includes a first plug 154 and a second plug 156 being shaped and sized for insertion into the first and second recessed abutment surfaces 146, 148 to form a substantially continuous surface across the first and second workpiece engagement member 128, 132. The first and second plugs 154, 156 are held into place through one or more threaded fastener 158 configured to engage the first or second workpiece engagement member 128, 132. In another example, with reference to FIG. 6, the bar clamp assembly 110 includes a snap-fit plug 160 useable with either the first or second workpiece engagement member 128, 132. In this configuration, the snap-fit plug 160 includes inwardly extending tabs 162 configured to engage grooves 164 formed in the first or second workpiece engagement members 128, 132 to maintain the snap-fit plug 160 within the recess forming the first or second abutment surface 146, 148.

In alternate configurations, it is contemplated that in contrast to the first and second support surfaces 150, 152 being integrally formed with the first and second workpiece engagement member 128, 132, respectively, and/or first and second abutment surfaces 146, 148, respectively, the first and second support surfaces are formed of separate components moveably attached to the first and second workpiece engagement members 128, 132.

For example, with reference FIG. 7, a first extendable support member 254, being separately formed from a first and second workpiece engagement member 228, 232, is shown. The first extendable support member 254 includes a cylindrical support surface 256 for supporting a workpiece. The first extendable support member 254 is attached to the first or second workpiece engagement member 228, 232 through a threaded portion 258. The threaded portion 258 is configured to engage a corresponding threaded portion 260 formed in an opening 262 of the first or second workpiece engagement member 228, 232. In this configuration, upon rotation the first extendable support member 254 in a first direction, the cylindrical support surface 256 moves out of the opening 262 to provide suitable support for a workpiece. Alternatively, the first extendable support member 254 may be rotated in an opposite direction to become recessed and form a substantially continuous surface over the first or second workpiece engagement member 228, 232 and/or become flush with a first or second abutment surface 246, 248.

In another alternate configuration, with reference to FIG. 8, a second extendable support member 354, being separately formed from a workpiece engagement member 332, is shown. It should be appreciated that the second extendable support member 354 is useable with a first workpiece engagement member. The second extendable support member 354 includes a substantially flat support surface 355 for providing support to a workpiece. The second extendable support member 354 is slidably mounted to an end portion 356 of the second workpiece engagement member 332. The second extendable support member 354 includes a groove 358 configured to receive a retaining member 360 that maintains the second extendable support member 354 adjacent the second workpiece engagement member 332. In this configuration, the retaining member 360 is attached to the second workpiece engagement member 332 through a threaded engagement that is suitable in strength to provide support to the retaining member 360 and second extendable support member 354. Through the sliding engagement between the second extendable support member 354 and the retaining member 360, the support member is allowed to extend past a second abutment surface 348 a suitable length ‘1’ to support a workpiece. When support is not needed, the sliding configuration allows the support member to be retracted to become flush or receded with respect to the second abutment surface 348 to form a substantially continuous surface over the second workpiece engagement member 332.

In still another alternate configuration, with reference to FIG. 9, a third extendable support member 454, being separately formed from a first or second workpiece engagement member 428, 432 is shown. The third extendable support member 454 includes a substantially flat support surface 455 for providing support to a workpiece. The third extendable support member 454 is rotatably mounted to an end portion 456 of a first or second workpiece engagement member 428, 432. The third extendable support member 454 includes an eccentrically formed opening 458, with respect to a center of the third extendable support member 454, for receiving a fastener 460. As the third extendable support member 454 rotates, the support surface 455 extends a length ‘1’ beyond a first or second abutment surface 446, 448. When use of the support surface 455 is not desired the third extendable support member 454 is rotated to be flush or recessed with respect to the first or second abutment surface 446, 448 to form a substantially continuous surface over the first of second workpiece engagement member 428, 432.

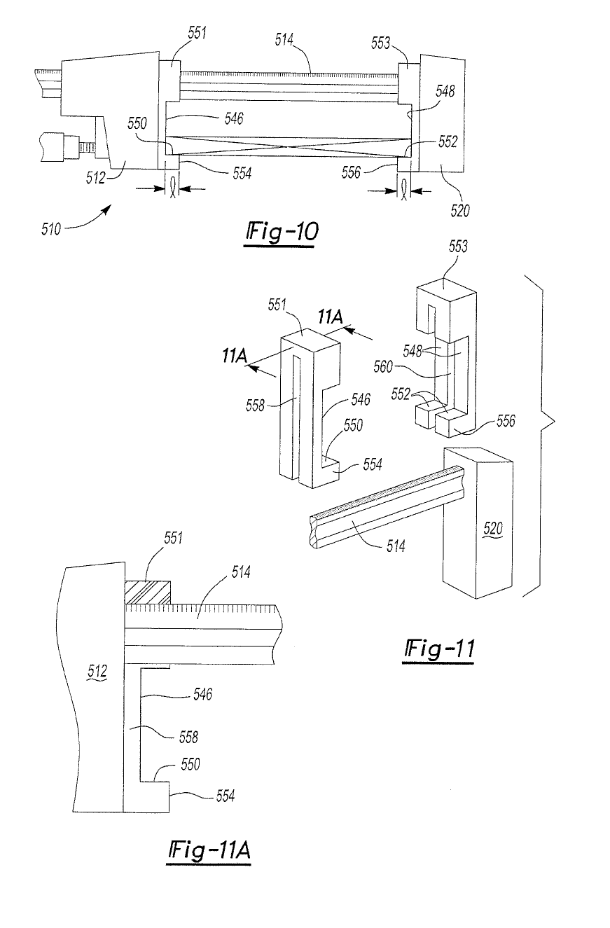

In another embodiment, referring to FIGS. 10 through 11A, it is contemplated that the support members need not be attached to a bar clamp assembly 510, but instead comprise a separate component useable with the bar clamp. In this configuration, the bar clamp assembly includes a first support member 551 located proximate the slide jaw 512 and a second support member 553 located proximate the fixed jaw 520. The first and second support members 551, 553 include first and second fingers 554, 556 forming first and second support surfaces 550, 552, respectively, and first and second abutment surfaces 546, 548. The first and second support members 551, 553 further include a first and second slot 558, 560 for mounting onto a guide rail 514 of the bar clamp assembly 510. In one embodiment, the first and second support member 551, 553 include a first and second snap-fitting 562, 564, respectively, for slideable attachment to the guide rail 514. In operation, the first and second support member 551, 553 rest over and are supported by the guide rail 514. As compressive pressure is applied to the first and second fingers 554, 556, via workpiece 526 and an edge clamp or other clamp mechanism, the first and second support members 551, 553 and hence workpiece 526 is supported by guide rail 514.

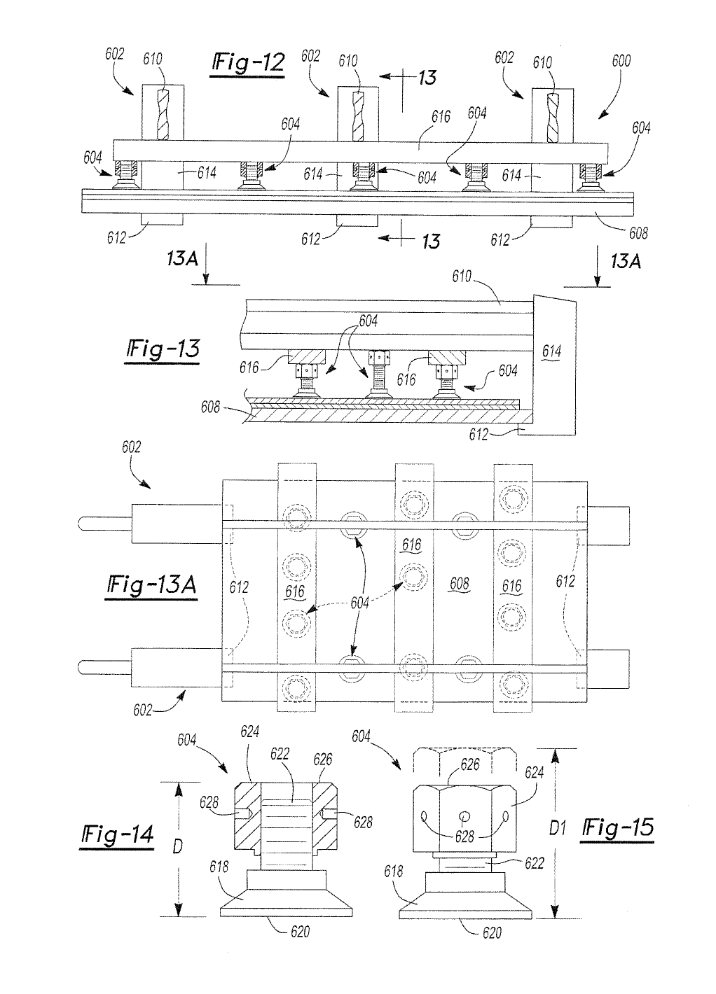

The present invention further includes improved clamp mechanisms usable with clamp systems for generating a compressive force non-parallel with respect to a rail axis and more so, in one particular configuration, generally perpendicular to the guide rail axis. For example, referring to FIGS. 12 through 17, clamp systems 600 are provided for joining multiple layers of a workpiece together. In these configurations, one or more bar clamp assemblies 602, such as described herein, are used in conjunction with edge clamps, also such as described herein, or alternate clamp mechanisms 604, 704 for the purpose of joining multiple layers of a workpiece together. In one particular configuration, the clamp mechanisms 604 are used with multiple bar clamp assemblies 602 to form the clamp system 600. The clamp mechanisms 604 comprise an expandable member configured to apply suitable force along the length and/or width of a workpiece 608. In doing so, the expandable members 606 are configured to expand from a first distance “D” to a second distance “D1”. The clamp mechanisms 604 may be directly or indirectly in contact with the workpiece 608 and guide rails 610 of the bar clamp assembly 602. In operation, the clamp mechanisms 604 expand to generate a compressive force against the workpiece 608 as a result of the counterforce generated by a guide rail 610 and support members 612 of a workpiece engagement members 614 of the bar clamp assembly 602.

In one configuration, with reference to FIGS. 12-15, a plurality of clamp mechanisms 604 are interposed between a workpiece 608 and guide rails 610 of a plurality of bar clamp assemblies 602. In this configuration, an additional force distribution member 616 is used to distribute pressure generated by the expandable clamp mechanisms 604 to the guide rails 610. The clamp mechanisms 604 include a base 618 having a first abutment surface 620 for contacting a surface of a workpiece. The clamp mechanisms 604 further include a threaded post 622, extending from the base portion, and a corresponding threaded member 624. The corresponding threaded member 624 includes a second abutment surface 626 for engagement with the force distribution member 616 or the guide rail 610 directly. The corresponding threaded member 624 is hexagonal in shape and includes one or more openings 628 formed on the sides for engagement with a tool and causing rotation of the corresponding threaded member 624. In operation, as the corresponding threaded member 624 rotates about the threaded post 622 the second abutment surface 626 moves with respect to the first abutment surface 620 causing compressive pressure against the workpiece 608 and guide rails 610, which may be further achieved via force distribution member 616.

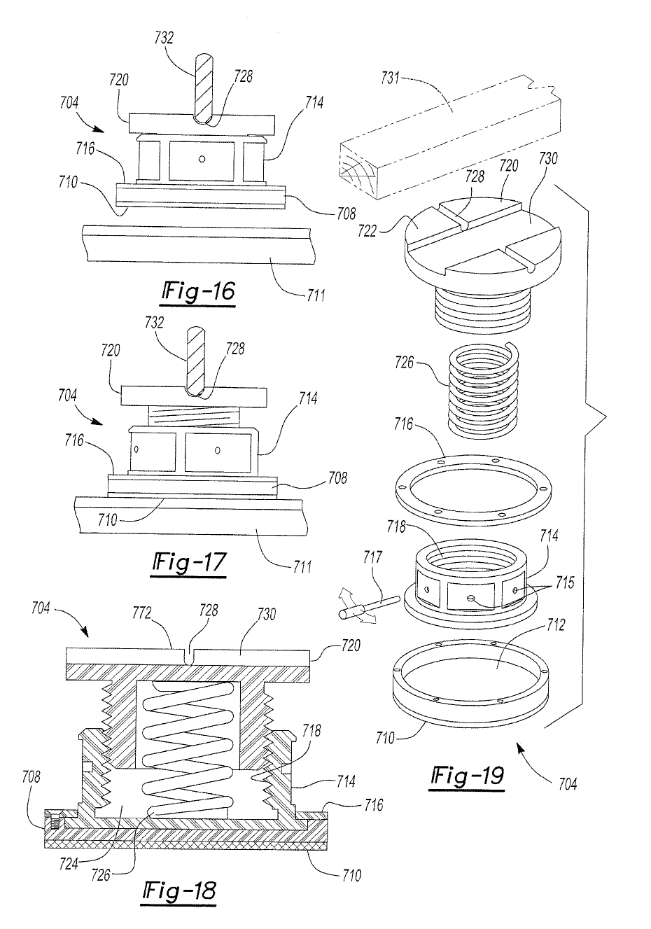

In a second configuration, referring again to FIGS. 16-19, an alternative clamp mechanism 704 is shown. The clamp mechanism 704 includes a base 708 having a first abutment surface 710 for contacting a surface of a workpiece 711. In this configuration, the base 708 includes a first cavity 712 for receiving and attachment to a threaded post 714 extending therefrom. The threaded post 714 is hexagonal in shape and includes one or more openings 715 formed on the sides for engagement with a tool 717 for causing rotation of the corresponding threaded post 714. During rotation, the threaded post 714 is held within the cavity by a removable retaining ring 716. The threaded post 714 further includes internal threads 718 for engagement with a corresponding threaded member 720 having a second abutment surface 722. The combination of the threaded post 714 and corresponding threaded member 720 forms a cavity 724 for receiving a spring 726 configured for maintaining pressure against the corresponding threaded member 720 and base 708. Advantageously, this continuous pressure causes friction between the threads of the threaded post 714 and corresponding threaded member 720 thereby limiting free rotation of the corresponding threaded member 720 with respect to the threaded post 714. In this configuration, the corresponding threaded member 720 includes a first groove 728 configured for engagement with guide rail 732 of a bar clamp assembly and a second groove 730 configured for engagement with a force distribution member 731. In operation, as the threaded post 714 is rotated the corresponding threaded member 720 moves with respect based 708 to generate compressive pressure against a workpiece and guide rail 732.

With respect to the embodiments described herein, it is contemplated that the support surfaces are suitable in length ‘1’ to provide sufficient strength for providing the support. While the length of the support surface may vary, as described herein, it is contemplated that the length ‘1’ of the support surfaces between an abutment surface and the end of the abutment surface are greater than about ¼ inch, ½ inch, ¾ inch, 1 inch or more.

It should be appreciated that certain features of the bar clamp assembly can be combined or used in lieu of features of other bar clamp assemblies. Also, edge clamps and other pressure generating device can be used with any of the bar clamp assemblies described herein.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A bar clamp assembly, comprising:
a guide rail extending along an axis between a first end and a second end;
a slide jaw disposed along the guide rail, the slide jaw including a first abutment surface and a first support surface;
a fixed jaw attached to the guide rail proximate the first or second end, the fixed jaw including a second abutment surface and a second support surface; and
a compress mechanism disposed with the slide jaw, the compress mechanism including a moveable member configured to move the first abutment surface towards the second abutment surface for generating a compressive force generally parallel to the guide rail axis,
wherein the first and second support surfaces provide reactionary force to compressive force applied generally perpendicular to the guide rail axis.

2. The bar clamp assembly of claim 1, wherein the first support surface is formed on a first support member extending away from the first abutment surface and the second support surface is formed on a second support member extending away from the second abutment surface.

3. The bar clamp assembly of claim 2, wherein the first support surface, second support surface or both extend at least about 0.25 inches beyond the first or second abutment surface, respectively.

4. The bar clamp assembly of claim 2, wherein the first support surface, second support surface or both extend at least about 0.5 inches beyond the first or second abutment surface, respectively.

5. The bar clamp assembly of claim 1, wherein the slide jaw includes a first workpiece engagement member, the first workpiece engagement member defines a first recess that forms the first abutment surface and the first support surface, and wherein the fixed jaw includes a second workpiece engagement member, the second workpiece engagement member defines a second recess that forms the second abutment surface and the second support surface.

6. The bar clamp assembly of claim 5, further comprising a first plug configured to fit within the first recess to form a substantially continuous surface area over the first workpiece engagement member, and further comprising a second plug configured to fit within the second recess to form a substantially continuous surface area over the second workpiece engagement member.

7. The bar clamp assembly of claim 6, wherein the first plug, second plug or both are attached to the first or second workpiece engagement member, respectively, through one or more fasteners.

8. The bar clamp assembly of claim 6, wherein the first plug, second plug or both are attached to the first or second workpiece engagement member, respectively, through a snap-fit engagement feature.

9. The bar clamp assembly of claim 1, wherein the first support surface, the second support surface or both are formed on support members that are moveably attached to the fixed jaw or slide jaw, respectively.

10. The bar clamp assembly of claim 9, wherein the support members are threadably attached to the fixed jaw or slide jaw such that the support members are moveable between a deployed position and a retracted position.

11. The bar clamp assembly of claim 9, wherein the support members are rotatably attached to the fixed jaw or slide jaw such that the support members are moveable between a deployed position and a retracted position.

12. The bar clamp assembly of claim 9, wherein the support members are slidably attached to the fixed jaw or slide jaw such that that the support members are moveable between a deployed position and a retracted position.

13. The bar clamp assembly of claim 1, wherein the first abutment surface and the first support surface are formed on a first common member that is removable from the slide jaw, and wherein the second abutment surface and the second support surface are formed on a second common member that is removable from the fixed jaw.

14. The bar clamp assembly of claim 13, wherein the first common member, the second common member, or both, are slideably attached to the guide rail through a snap-fitting.

15. The bar clamp assembly of claim 13, wherein the compressive forces applied generally perpendicular to the guide rail is generated by one or more clamp mechanisms disposed between the guide rail and the first support surface and second support surface, the one or more clamp mechanisms being configured to expand to cause the compressive force that is generally perpendicular to the guide rail.

16. A clamp system for joining multiple layers of a workpiece together, the clamp system comprising:
a plurality of bar clamp assemblies, each of the plurality of bar clamp assemblies including:
a guide rail extending along an axis between a first end and a second end;
a slide jaw disposed along the guide rail, the slide jaw including a first abutment surface and a first support surface;
a fixed jaw attached to the guide rail proximate the first or second end, the fixed jaw including a second abutment surface and a second support surface; and
a compress mechanism disposed with the slide jaw, the compress mechanism including a moveable member configured to move the first abutment surface towards the second abutment surface for generating a compressive force generally parallel to the guide rail axis,
wherein the first and second support surfaces provide reactionary force to compressive force applied generally perpendicular to the guide rail axis; and
one or more clamp mechanisms disposed between the guide rail and the first support surface and second support surface, the one or more clamp mechanisms being configured to expand to cause the compressive force that is generally perpendicular to the guide rail.

17. The clamp system of claim 16, wherein the one or more clamp mechanisms engage guide rails of the plurality of bar clamp assemblies at a first end and a workpiece at a second end.

18. The clamp system of claim 17, wherein the one or more clamp mechanisms includes a groove for receiving a portion of the guide rails.

19. The clamp system of claim 16, further comprising a force distribution member disposed between the one or more clamp mechanisms and the guide rails of the plurality of bar clamp assemblies, the one or more clamp mechanisms engage the force distribution member at a first end and a workpiece at a second end.

20. The clamp system of claim 16, wherein the first abutment surface and the first support surface are formed on a first common member that is removable from the slide jaw, and wherein the second abutment surface and the second support surface are formed on a second common member that is removable from the fixed jaw.
